(19) United States
(12) Patent Application Publication
(10) Pub. No.: US 2007/0194772 A1
(43) Pub. Date: Aug. 23, 2007

(54) Assessing soundness of motor-driven devices

(76) Inventors: Joshua M. Fix, Glen Carbon, IL (US); Wayne R. Majkowski, Florissant, MO (US); Kevin L. Swearingen, St. Charles, MO (US); Kirby J. Keller, Chesterfield, MO (US)

Correspondence Address: HARNESS DICKEY & PIERCE, PLC, P.O. BOX 828, BLOOMFIELD HILLS, MI, 48303, US

(21) Appl. No.: 11/358,189

(22) Filed: Feb. 20, 2006

(51) Int. Cl. F04B 51/00; G01M 19/00

(52) U.S. Cl. 324/71.1; 73/168; 73/116; 702/182; 702/115

(57) ABSTRACT

A method of assessing soundness of a motor-driven device, i.e., a fuel pump. The method includes sampling power input while providing substantially constant power to the motor. A frequency spectrum of the sampled input is used to determine an efficiency of the motor. The determined efficiency is related to soundness of the device and/or motor. This method makes it possible to assess fuel pump performance without having to gain physical access to the pump.

### STATEMENT REGARDING FEDERALLY SPONSORED RESEARCH OR DEVELOPMENT

This invention was made with Government support under contract F33615-03-2-2305 awarded by the United States Air Force. The Government has certain rights in this invention.

### FIELD

The present disclosure relates generally to motor-driven devices and more particularly (but not exclusively) to systems and methods for assessing soundness of motor-driven devices, including but not limited to motor-driven fuel pumps.

### BACKGROUND

The statements in this section merely provide background information related to the present disclosure and may not constitute prior art.

In commercial and military aircraft, fuel pumps generally are used to distribute fuel among a plurality of fuel tanks and to provide fuel to aircraft engines. During flight, aircraft fuel pumps may operate almost constantly to provide weight distribution, stabilization and consistent engine power. In the interest of aircraft safety, fuel pumps may be replaced at predetermined usage intervals. When a fuel pump is located inside a fuel tank, replacing the pump can be difficult, time consuming and expensive.

### SUMMARY

In one implementation, the disclosure is directed to a method of assessing soundness of a motor-driven device. The method includes sampling power input while providing substantially constant power to the motor. A frequency spectrum of the sampled input is used to determine an efficiency of the motor. The determined efficiency is related to soundness of the device and/or motor.

In another implementation, a vehicle control system includes a controller configured to sample current input to a motor driving a fuel pump of the vehicle while power input to the motor is substantially constant. The controller associates a frequency shift of the sampled input current with a change in speed of the motor, and relates the change in speed to soundness of at least one of the pump and motor.

In yet another implementation, the disclosure is directed to a method of assessing soundness of a motor-driven pump. The method includes sampling current input to the motor while the motor receives substantially constant power. A difference is determined between an observed frequency and a reference frequency in a frequency spectrum of the sampled current input. The difference is related to soundness of the pump and/or motor.

Further areas of applicability will become apparent from the description provided herein. It should be understood that the description and specific examples, while indicating various preferred embodiments of the disclosure, are intended for purposes of illustration only and are not intended to limit the scope of the present disclosure.

### DRAWINGS

The drawings described herein are for illustrative purposes only and are not intended to limit the scope of the present disclosure in any way.

FIG. 1 is a schematic diagram of a system for assessing soundness of a motor-driven device in accordance with one implementation of the disclosure;

FIG. 2 is a schematic diagram illustrating a method of assessing soundness of a motor-driven device in accordance with one implementation of the disclosure; and

FIGS. 3A through 3D are graphs of frequency spectra indicative of fuel pump soundness and/or motor soundness in accordance with one implementation of the disclosure.

### DETAILED DESCRIPTION

The following description is merely exemplary in nature and is in no way intended to limit the present disclosure, application, or uses.

Although various implementations of the disclosure are described with reference to aircraft fuel pumps powered by brushless DC motors, the disclosure is not so limited. Implementations are contemplated in connection with various motor-driven devices and in connection with various types of electrical motors. Such implementations may or may not be vehicle-related. Implementations also are contemplated in connection with various vehicle applications, including but not limited to aerospace and non-aerospace applications.

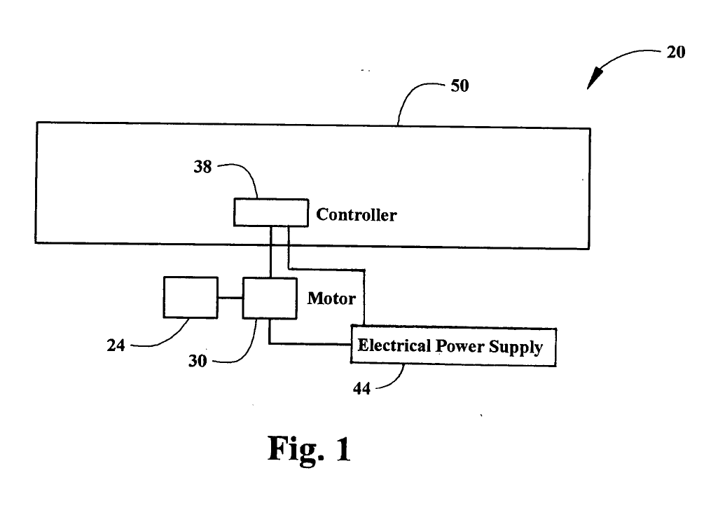

In various implementations of the disclosure, systems and methods are provided for assessing soundness of motor-driven devices by analysis of electrical power usage. One implementation of such a system is indicated generally in FIG. 1 by reference number 20. The system 20 is configured for assessing the soundness of a device 24 driven by a motor 30. A controller 38 controls operation of the motor 30, which receives electrical power from a power supply 44. The term “controller” is used herein to refer to any component or configuration that provides functionality as described in the present disclosure. Thus a “controller” may include but is not limited to application-specific circuit(s), electronic and/or electromechanical configuration(s), computer(s), processor(s) and memory for executing software and/or firmware, and/or combinational logic circuit(s).

In the present example, the controller 38 is included in a system 50 that senses current to monitor electrical power to the motor 30. There are many ways, however, of configuring a controller with a larger system in accordance with the present disclosure. The system 50, for example, could include fewer than all components of the controller 38 in some configurations. Implementations also are contemplated in which the controller 38 is configured to perform current-sensing. Additionally or alternatively, in some configurations the controller 38 may not be part of a larger system.

In various implementations, the system 20 may be a vehicle control system. In the present example, the system 20 is an aircraft control system and the device 24 is a fuel pump of the aircraft. The system 50 is, e.g., a power distribution unit (PDU) that monitors currents in a plurality of loads on the aircraft, including currents to a plurality of motor-driven fuel pumps 24, one of which is shown in FIG. 1.

The, controller 38 receives state data pertaining to the motor 30 and sends control signals to the motor 30. It should be noted that although a single motor-driven fuel pump 24 is shown in FIG. 1, the controller 38 may control more than one motor-driven fuel pump 24. The motor 30 is, e.g., a brushless DC motor driven in accordance with pulse-width modulation (PWM) signals from the controller 38.

In one implementation, a method of assessing soundness of the pump 24 and/or motor 30 includes sampling power input while providing substantially constant power to the motor 30. A frequency spectrum of the sampled input is used to determine an efficiency of the motor 30. The determined efficiency is related to soundness of the pump 24 and/or motor 30.

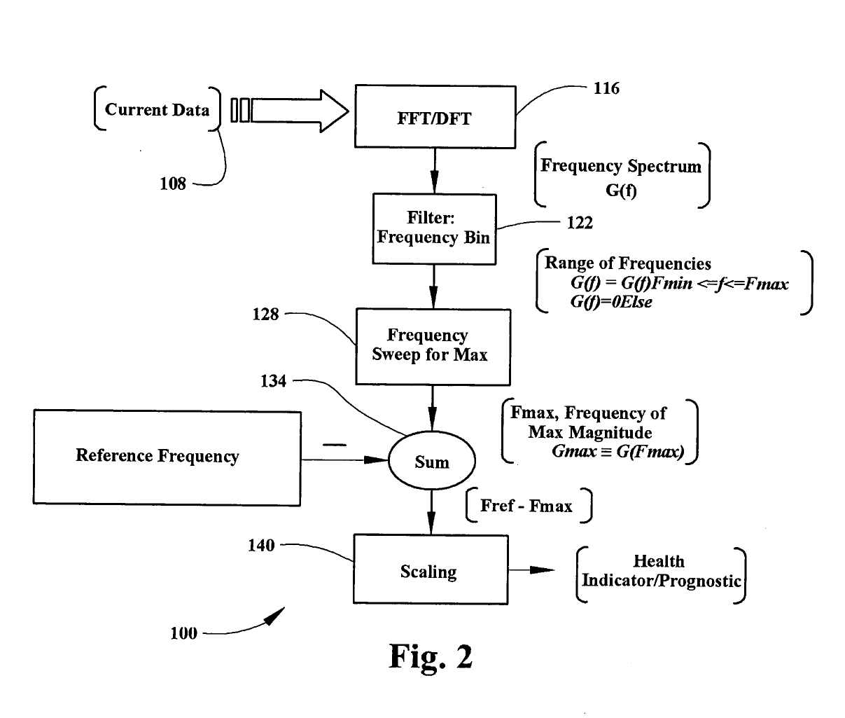

One implementation of a method of assessing soundness of the pump 24 is indicated generally in FIG. 2 by reference number 100. In operation 108, input current to the motor is sampled while the motor is driven at substantially constant power. In operation 116, a Fourier transform (preferably a fast Fourier transform (FFT) or digital Fourier transform (DFT)) is performed on the sample data. A resulting frequency spectrum G(f) can be analyzed to determine whether, and if so, to what extent, a load on the motor 30 includes loading due to degradation of the pump 24 and/or motor 30. If the pump 24 and motor 30 are sound, current supplied to the motor 30 at a nominal command frequency (also called reference frequency F_{ref}) displays an energy maximum substantially at the reference frequency F_{ref} in the frequency spectrum G(f).

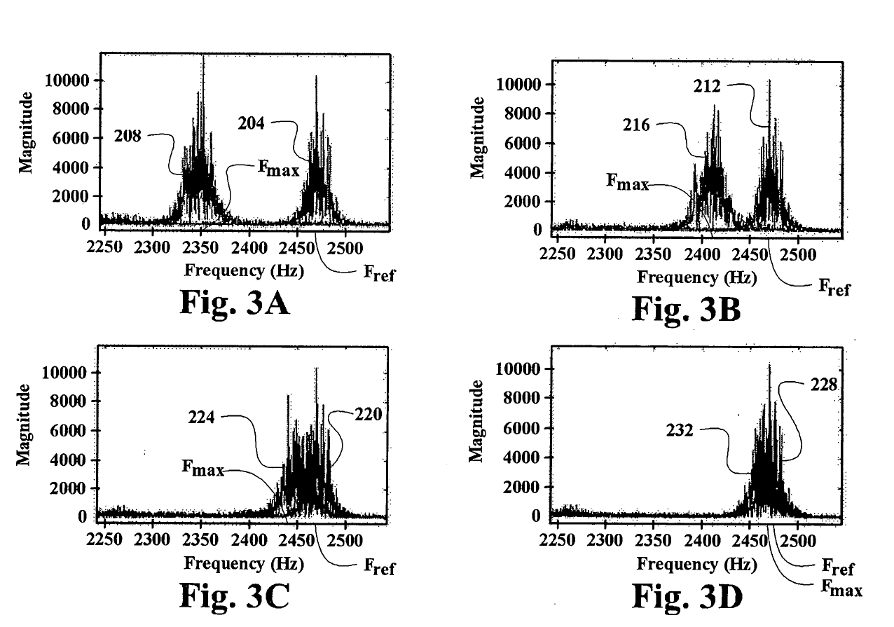

Exemplary frequency spectra indicative of fuel pump and/or motor soundness are shown in FIGS. 3A-3D. In each of FIGS. 3A-3D, a frequency spectrum of a sound pump and motor is overlaid on a frequency spectrum of a less-than-sound pump and/or motor. In FIG. 3A is shown a spectrum 204 of a sound pump and motor and a spectrum 208 of a failed pump and/or motor. In FIG. 3B is shown a spectrum 212 of a sound pump and motor and a spectrum 216 of a pump and/or motor in poor condition. In FIG. 3C is shown a spectrum 220 of a sound pump and motor and a spectrum 224 of a pump and motor in a medium state of soundness. In FIG. 3D is shown a spectrum 228 of a sound pump and motor and a spectrum 232 of a slightly degraded pump and/or motor.

Motor loading related to pump and/or motor degradation can be determined by identifying and analyzing specific local maxima in energy, particularly maxima near the nominal command frequency F_{ref}. As the motor is loaded, a center frequency (referred to in FIGS. 3A-3D as Fₘₐₓ) of these energy peaks shifts away from the control frequency F_{ref}. These shifts in current signature are related to the motor RPM.

Referring again to FIG. 2, in operation 122 the spectrum G(f) is filtered to obtain one or more frequency ranges. In operation 128 the range(s) are swept to determine a frequency of a maximum magnitude, i.e., Fₘₐₓ. In operation 134, a shift in the observed frequency Fₘₐₓ from the reference frequency F_{ref} is determined by obtaining a difference between Fₘₐₓ and the reference frequency F_{ref} associated with a healthy pump or other device. Since the power to the motor 30 is constant, the decrease in RPM as indicated by the frequency shift (F_{ref—}Fₘₐₓ) is attributable to increased load on the motor 30 which can be caused by such degradations as bearing failure, impeller rub and/or foreign objects in a fluid being pumped.

In some implementations in which noise is or may be present, the frequency shift may be calculated by averaging frequencies in a neighborhood around a maximum frequency. The frequency difference (F_{ref—}Fₘₐₓ) may be scaled in operation 140 to provide a health indicator which may be tracked over time to show a measurable trend in pump and/or motor degradation. Such a trend may be projected over time to provide a prediction as to future soundness of the motor and/or pump. In aircraft applications, motor/pump health indicators can be offloaded from an aircraft, e.g., to a data warehouse after flight and monitored over time to reveal trends in performance degradation. Motor/pump health indicators can also be used as a diagnostic tool during flight, to determine whether pump failure may be imminent and to provide a basis for corrective action.

Where the magnitude of the shift (F_{ref—}Fₘₐₓ) is observed to increase gradually over time, pump/motor performance and expected life typically degrade gracefully. Thus various implementations of the disclosure can provide gray-scale health assessment for motor-driven fuel pumps and/or other motor-driven devices. The foregoing implementations do not require additional sensors or modification to a pump or pump control. Analyzing the frequency characteristics of a pump's electrical power supply provides informative data directly relating to the commutation rate of the motor. This data can be used to expose information characterizing pump performance without any need for physical access to the pump itself. Algorithms for analyzing such data can be installed and executed directly on a pre-existing aircraft power distribution unit (PDU) or other pre-existing current sensing system, without modification to pre-existing data infrastructure of the aircraft.

Various implementations of the disclosure can provide incremental, gray-scale pump health status information. Such information is independent of aircraft go/nogo status indicators currently used for monitoring fuel pumps during flight. Thus the foregoing systems and methods can provide corroboration of go/nogo status indicators, thereby bolstering confidence in both assessments.

Additionally, the foregoing systems and methods can be used to measure motor/pump efficiency that can change gradually as a pump is loaded due, e.g., to bearing wear, impeller dragging and/or foreign objects. Unexpected motor loading can be trended, e.g., to predict future motor/pump status. The foregoing systems and methods can bolster confidence in pump performance, making it possible, e.g., to lengthen intervals of pump usage between pump removals. Additionally, because unanticipated maintenance can be reduced, maintenance costs can be reduced and aircraft flight availability can be improved.

While various preferred embodiments have been described, those skilled in the art will recognize modifications or variations which might be made without departing from the inventive concept. The examples illustrate the disclosure and are not intended to limit it. Therefore, the description and claims should be interpreted liberally with only such limitation as is necessary in view of the pertinent prior art.

What is claimed is:

1. A method of assessing soundness of a motor-driven device, the method comprising:
sampling power input while providing substantially constant power to the motor;
using a frequency spectrum of the sampled input to determine an efficiency of the motor; and
relating the determined efficiency to soundness of the device and/or motor.

2. The method of claim 1, further comprising:
comparing a frequency in the spectrum to a reference frequency to determine the motor efficiency.

3. The method of claim 1, further comprising associating a current frequency shift with a change in speed of the motor.

4. The method of claim 1, wherein the device includes a fuel pump of an aircraft, and at least the sampling is performed by a pre-existing power distribution unit of the aircraft.

5. The method of claim 1, wherein the device includes a vehicle fuel pump, and at least the sampling is performed using a pre-existing current sensing system of the vehicle.

6. The method of claim 1 performed a plurality of times to determine a trend in soundness of the device and/or motor.

7. The method of claim 1 wherein the device includes a fuel pump of an aircraft, and at least the sampling is performed during flight.

8. The method of claim 1, wherein using a frequency spectrum of the sampled input comprises using a current signature of the motor.

9. A vehicle control system comprising a controller configured to:
sample current input to a motor driving a fuel pump of the vehicle while power input to the motor is substantially constant;
associate a frequency shift of the sampled input current with a change in speed of the motor; and
relate the change in speed to soundness of at least one of the pump and motor.

10. The vehicle control system of claim 9, wherein the controller is configured to analyze a spectrum of the sampled input current to determine a load on the motor.

11. The vehicle control system of claim 9, wherein the motor comprises a brushless DC motor.

12. The vehicle control system of claim 9, wherein the controller is configured to compare a frequency of the sampled input current to a reference current frequency to determine the frequency shift.

13. The vehicle control system of claim 12, wherein the controller is configured to, if noise is present, compare an average of a plurality of frequencies in a spectrum of the sampled input current to the reference frequency to determine the frequency shift.

14. The vehicle control system of claim 9, wherein the vehicle includes an aerospace vehicle, the system further comprising a power distribution unit that includes at least a portion of said controller.

15. A method of assessing soundness of a motor-driven pump, the method comprising:
sampling current input to the motor while the motor receives substantially constant power;
determining a difference between an observed frequency and a reference frequency in a frequency spectrum of the sampled current input; and
relating the difference to soundness of the pump and/or motor.

16. The method of claim 15, wherein determining a difference comprises:
filtering one or more ranges of frequencies of the spectrum to determine an energy maximum; and
determining a difference between a frequency of the energy maximum and the reference frequency.

17. The method of claim 15, wherein determining a difference comprises performing a Fourier transform on the sampled current.

18. The method of claim 15, further comprising predicting soundness of the pump and/or motor based on a plurality of performances of said method over time.

19. The method of claim 15, wherein the reference frequency is associated with the pump and motor in sound condition.

20. The method of claim 15, further comprising:
scaling the frequency difference; and
using the scaled difference over time to track and/or predict soundness of the pump and/or motor.
